(19) United States
(12) Patent Application Publication
(10) Pub. No.: US 2024/0359101 A1
(43) Pub. Date: Oct. 31, 2024

(54) COMPUTER-READABLE MEDIA, INFORMATION PROCESSING SYSTEM, INFORMATION PROCESSING APPARATUS, AND INFORMATION PROCESSING METHOD

(71) Applicant: NINTENDO CO., LTD., Kyoto (JP)

(72) Inventors: Naoki FUKADA, Kyoto (JP); Akira FURUKAWA, Kyoto (JP); Kazuhiro KAWAMURA, Kyoto (JP)

(21) Appl. No.: 18/400,828

(22) Filed: Dec. 29, 2023

(30) Foreign Application Priority Data
Apr. 27, 2023 (JP) 2023-073338

(51) Int. Cl. A63F 13/57

(52) U.S. Cl. CPC A63F 13/57

(57) ABSTRACT

In an example of a game according to an exemplary embodiment, each of propulsive objects among dynamic objects placed in a virtual space and capable of moving is caused to generate a propulsive force, and the propulsive object is moved in the virtual space based on physical calculations. The propulsive force is attenuated in accordance with a magnitude of a component of a moving velocity of the propulsive object along a direction of the propulsive force, and when the component along the direction of the propulsive force exceeds a predetermined reference value, the propulsive force is controlled to become zero.

### CROSS REFERENCE TO RELATED APPLICATION

This application claims priority to Japanese Patent Application No. 2023-073338 filed on Apr. 27, 2023, the entire contents of which are incorporated herein by reference.

### FIELD

An exemplary embodiment relates to one or more non-transitory computer-readable storage media having stored therein a game program, an information processing system, an information processing apparatus, and an information processing method.

### BACKGROUND AND SUMMARY

Conventionally, there is a game where a player character can move while mounting a predetermined object.

In such a game where an object moves, if the optional application of a propulsive force to the object should be enabled, the object may reach a velocity beyond a range accepted in a game system.

Therefore, an exemplary embodiment discloses a game program, an information processing system, an information processing apparatus, and an information processing method that are capable of applying a propulsive force to an object and also performing control so that the object is less likely to reach a velocity beyond an accepted range.

The exemplary embodiment employs the following configurations.

### (First Configuration)

Instructions according to a first configuration, when executed, cause one or more processors of an information processing apparatus to execute game processing including: controlling each of propulsive objects that generates a propulsive force and moves at least based on the propulsive force among dynamic objects which are placed in a virtual space and of which movements are controlled based on physical calculations: attenuating the propulsive force of the propulsive object in accordance with a moving velocity of the propulsive object; and when the moving velocity based on physical calculations exceeds a predetermined reference, controlling the propulsive force to be zero.

Based on the above, when the moving velocity of a propulsive object exceeds a predetermined reference, the propulsive force of the propulsive object is controlled to become zero. Thus, it is possible to prevent a propulsive object from reaching a velocity beyond an accepted range.

### (Second Configuration)

According to a second configuration, in the above first configuration, the game processing may further include forming an assembly object by linking a plurality of the dynamic objects based on an operation input.

Based on the above, it is possible to form an assembly object by linking a plurality of dynamic objects.

### (Third Configuration)

According to a third configuration, in the above second configuration, the game processing may further include: regarding each of the dynamic objects included in the assembly object, determining a moving velocity based on physical calculations using forces from the dynamic objects to which the dynamic object is linked; and regarding each of the propulsive objects included in the assembly object, attenuating the propulsive force of the propulsive object in accordance with the moving velocity of the propulsive object.

Based on the above, regarding each of propulsive objects in the assembly object, it is possible to attenuate the propulsive force in accordance with the velocity of the propulsive object.

### (Fourth Configuration)

According to a fourth configuration, in the above first to third configurations, the game processing may further include attenuating the propulsive force in accordance with a component of the moving velocity along a direction of the propulsive force. The predetermined reference may be that the component along the direction of the propulsive force reaches a predetermined reference value.

Based on the above, it is possible to attenuate the propulsive force in accordance with a component of the moving velocity of the propulsive object along the direction of the propulsive force. If the component reaches a predetermined reference value, it is possible to control the propulsive force of the propulsive object to become zero.

### (Fifth Configuration)

According to a fifth configuration, in the above first to fourth configurations, the game processing may further include, for a first propulsive object having a first state and a second state among the propulsive objects, continuously generating the propulsive force in a predetermined direction in the first state.

Based on the above, if a first propulsive object is in a first state, it is possible to generate the propulsive force in a predetermined direction.

### (Sixth Configuration)

According to a sixth configuration, in the above fifth configuration, the game processing may further include, if the first propulsive object is not a part of an assembly object and is in a predetermined orientation, controlling the first propulsive object not to generate the propulsive force in the first state.

Based on the above, if the first propulsive object is in a predetermined orientation, it is possible to prevent the first propulsive object from generating the propulsive force even in the first state. For example, it is possible to maintain the first propulsive object in the predetermined orientation.

### (Seventh Configuration)

According to a seventh configuration, in the above fifth configuration, the propulsive objects may include a second propulsive object. The game processing may further include causing the first propulsive object to generate a contact determination area in the virtual space in addition to the propulsive force, and if the contact determination area comes into contact with the second propulsive object, causing the second propulsive object to generate the propulsive force.

Based on the above, it is possible to cause a second propulsive object to generate the propulsive force.

### (Eighth Configuration)

According to an eighth configuration, in the above seventh configuration, the game processing may further include, if the contact determination area except for the contact determination area generated by the first propulsive object included in an assembly object including the second propulsive object and the second propulsive object come into contact with each other, causing the second propulsive object to generate the propulsive force.

Based on the above, if the first propulsive object and the second propulsive object are included in the same assembly object, it is possible to prevent the second propulsive object from generating the propulsive force regarding a contact determination area generated by the first propulsive object.

### (Ninth Configuration)

According to a ninth configuration, in the above fourth configuration, the game processing may further include causing a third propulsive object among the propulsive objects to generate the propulsive force for a predetermined period from a timing specified based on an operation input.

Based on the above, it is possible to cause a third propulsive object to generate the propulsive force for a predetermined period.

### (Tenth Configuration)

According to a tenth configuration, in the above ninth configuration, the game processing may further include, while the propulsive force is being generated in the third propulsive object, increasing mass and an inertia tensor of the third propulsive object used in the physical calculations.

Based on the above, while the propulsive force is being generated in the third propulsive object, it is possible to increase the mass of the third propulsive object. For example, it is possible to apply a great force to another object in contact with the third propulsive object.

### (Eleventh Configuration)

According to an eleventh configuration, in the above fourth configuration, the game processing may further include causing a fourth propulsive object among the propulsive objects to generate the propulsive force in an up direction in the virtual space.

Based on the above, it is possible to cause a fourth propulsive object to generate the propulsive force upward in a virtual space.

### (Twelfth Configuration)

According to a twelfth configuration, in the above eleventh configuration, the game processing may further include controlling the fourth propulsive object so that the greater a predetermined parameter applied based on game processing is, the more increased the propulsive force for the fourth propulsive object and the reference value are.

Based on the above, it is possible to increase the propulsive force of the fourth propulsive object in accordance with a predetermined parameter and also increase the reference value until the propulsive force becomes zero.

### (Thirteenth Configuration)

According to a thirteenth configuration, in the above eleventh or twelfth configuration, the game processing may further include, while the propulsive force is being generated in the fourth propulsive object, increasing mass and an inertia tensor of the fourth propulsive object used in the physical calculations.

Based on the above, while the propulsive force is being generated in the fourth propulsive object, it is possible to increase the mass of the fourth propulsive object. For example, it is possible to apply a great force to another object in contact with the fourth propulsive object.

Another configuration may be an information processing system, or may be an information processing apparatus, or may be an information processing method.

According to the exemplary embodiment, it is possible to attenuate the propulsive force of a propulsive object in accordance with the moving velocity of the propulsive object. Thus, it is possible to prevent the propulsive object from reaching a velocity beyond an accepted range.

These and other objects, features, aspects and advantages of the exemplary embodiments will become more apparent from the following detailed description of the exemplary embodiments when taken in conjunction with the accompanying drawings.

### BRIEF DESCRIPTION OF THE DRAWINGS

FIG. 1 is an example non-limiting diagram showing a game system;

FIG. 2 is an example non-limiting block diagram showing an exemplary internal configuration of the main body apparatus 2:

FIG. 3 is an example non-limiting diagram showing an example of a game image displayed in a case where a game according to an exemplary embodiment is executed:

FIG. 4 is an example non-limiting diagram showing an example of a game image displayed when a dynamic object 31 is being operated based on an object operation action of a player character PC:

FIG. 5 is an example non-limiting diagram showing an example of a game image displayed when a fan object 31a is being moved based on the object operation action:

FIG. 6 is an example non-limiting diagram showing an example of an assembly object generated based on the object operation action and an example of an airplane object 40 including the fan object 31a and a wing object 31d:

FIG. 7 is an example non-limiting diagram illustrating control over the propulsive force of a propulsive object when the propulsive object is moving:

FIG. 8 is an example non-limiting diagram showing the relationship between the magnitude of a propulsive force direction component S of the velocity of the propulsive object and the magnitude of a propulsive force F:

FIG. 9 is an example non-limiting diagram showing an example of an assembly object including the wing object 31g and a plurality of propulsive objects and is an example non-limiting diagram showing an example of control over the propulsive force of each propulsive object:

FIG. 10 is an example non-limiting diagram showing an example of an assembly object including the wing object 31g and a plurality of propulsive objects and is an example non-limiting diagram showing a case where the velocities of the propulsive objects are different from each other:

FIG. 11 is an example non-limiting diagram showing a behavior relating to the state of a rocket object 31c:

FIG. 12 is an example non-limiting diagram showing a behavior relating to the state of the fan object 31a:

FIG. 13 is an example non-limiting diagram showing an example of a game image displayed when an assembly object including a sail object 31d moves:

FIG. 14 is an example non-limiting diagram showing an example of a game image after a predetermined time elapses after the state of FIG. 13:

FIG. 15 is an example non-limiting diagram showing an example of an assembly object 44 including a second fan object 31ab, the sail object 31g, and a board object 31f:

FIG. 16 is an example non-limiting diagram showing the difference between the direction of the propulsive force of a balloon object 31e and the propulsive force due to the heat:

FIG. 17 is an example non-limiting diagram showing the relationship between the magnitude of the propulsive force direction component S of the velocity of the balloon object 31e and the magnitude of a propulsive force Fe:

FIG. 18 is an example non-limiting diagram showing an example of data stored in a memory of the main body apparatus 2 during the execution of game processing;

FIG. 19 is an example non-limiting flow chart showing an example of game processing executed by a processor 21; and

FIG. 20 is an example non-limiting flow chart showing an example of an object update process in step S103.

### DETAILED DESCRIPTION OF NON-LIMITING EXAMPLE EMBODIMENTS

### (Game System Configuration)

A game system according to an example of an exemplary embodiment is described below. FIG. 1 is a diagram showing an exemplary game system. An example of a game system 1 according to the exemplary embodiment includes a main body apparatus (an information processing apparatus; which functions as a game apparatus main body in the exemplary embodiment) 2, a left controller 3, and a right controller 4. The main body apparatus 2 is an apparatus for performing various processes (e.g., game processing) in the game system 1. The left controller 3 includes a plurality of buttons 5L (up, down, left, and right direction keys) and an analog stick 6L as exemplary operation units through which a user provides input. The right controller 4 includes a plurality of buttons 5R (an A-button, a B-button, an X-button, and a Y-button) and an analog stick 6R as exemplary operation units through which the user provides input. An L-button 7L is provided on an upper surface of the left controller 3, and an R-button 7R is provided on an upper surface of the right controller 4.

Each of the left controller 3 and the right controller 4 is attachable to and detachable from the main body apparatus 2. That is, the game system 1 can be used as a unified apparatus obtained by attaching each of the left controller 3 and the right controller 4 to the main body apparatus 2, or the main body apparatus 2, the left controller 3, and the right controller 4 may be separated from one another, when being used. It should be noted that hereinafter, the left controller 3 and the right controller 4 will occasionally be referred to collectively as a “controller”.

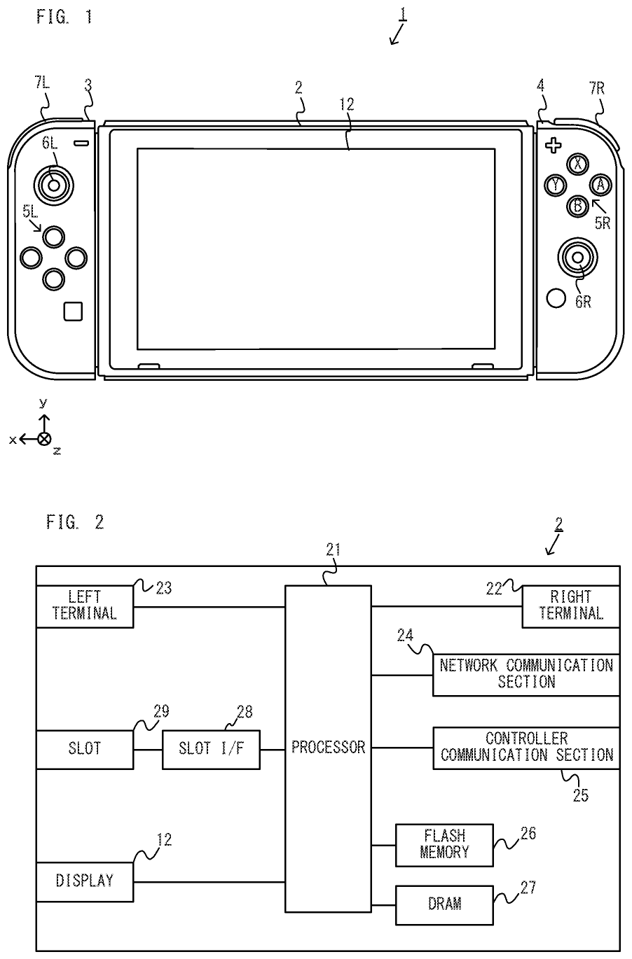

FIG. 2 is a block diagram showing an example of the internal configuration of the main body apparatus 2. As shown in FIG. 2, the main body apparatus 2 includes a processor 21. The processor 21 is an information processing section for executing various types of information processing (e.g., game processing) to be executed by the main body apparatus 2, and for example, includes a CPU (Central Processing Unit) and a GPU (Graphics Processing Unit). Note that the processor 21 may be configured only by a CPU, or may be configured by a SoC (System-on-a-Chip) that includes a plurality of functions such as a CPU function and a GPU function. The processor 21 executes an information processing program (e.g., a game program) stored in a storage section (specifically, an internal storage medium such as a flash memory 26, an external storage medium attached to the slot 29, or the like), thereby performing the various types of information processing.

Further, the main body apparatus 2 also includes a display 12. The display 12 displays an image generated by the main body apparatus 2. In the exemplary embodiment, the display 12 is a liquid crystal display device (LCD). The display 12, however, may be a display device of any type. The display 12 is connected to the processor 21. The processor 21 displays a generated image (e.g., an image generated by executing the above information processing) and/or an externally acquired image on the display 12.

Further, the main body apparatus 2 includes a left terminal 23, which is a terminal for the main body apparatus 2 to perform wired communication with the left controller 3, and a right terminal 22, which is a terminal for the main body apparatus 2 to perform wired communication with the right controller 4.

Further, the main body apparatus 2 includes a flash memory 26 and a DRAM (Dynamic Random Access Memory) 27 as examples of internal storage media built into the main body apparatus 2. The flash memory 26 and the DRAM 27 are connected to the processor 21. The flash memory 26 is a memory mainly used to store various data (or programs) to be saved in the main body apparatus 2. The DRAM 27 is a memory used to temporarily store various data used for information processing.

The main body apparatus 2 includes a slot 29. The slot 29 is so shaped as to allow a predetermined type of storage medium to be attached to the slot 29. The predetermined type of storage medium is, for example, a dedicated storage medium (e.g., a dedicated memory card) for the game system 1 and an information processing apparatus of the same type as the game system 1. The predetermined type of storage medium is used to store, for example, data (e.g., saved data of a game application or the like) used by the main body apparatus 2 and/or a program (e.g., a game program or the like) executed by the main body apparatus 2.

The main body apparatus 2 includes a slot interface (hereinafter abbreviated as “I/F”) 28. The slot I/F 28 is connected to the processor 21. The slot I/F 28 is connected to the slot 29, and in accordance with an instruction from the processor 21, reads and writes data from and to the predetermined type of storage medium (e.g., a dedicated memory card) attached to the slot 29.

The processor 21 appropriately reads and writes data from and to the flash memory 26, the DRAM 27, and each of the above storage media, thereby performing the above information processing.

The main body apparatus 2 includes a network communication section 24. The network communication section 24 is connected to the processor 21. The network communication section 24 performs wired or wireless communication with an external apparatus via a network. In the exemplary embodiment, as a first communication form, the network communication section 24 connects to a wireless LAN and communicates with an external apparatus, using a method compliant with the Wi-Fi standard. Further, as a second communication form, the network communication section 24 wirelessly communicates with another main body apparatus 2 of the same type, using a predetermined communication method (e.g., communication based on a unique protocol or infrared light communication). It should be noted that the wireless communication in the above second communication form achieves the function of enabling so-called “local communication” in which the main body apparatus 2 can wirelessly communicate with another main body apparatus 2 placed in a closed local network area, and the plurality of main body apparatuses 2 directly communicate with each other to transmit and receive data.

The main body apparatus 2 includes a controller communication section 25. The controller communication section 25 is connected to the processor 21. The controller communication section 25 wirelessly communicates with the left controller 3 and/or the right controller 4. The communication method between the main body apparatus 2 and the left controller 3 and the right controller 4 is optional. In the exemplary embodiment, the controller communication section 25 performs communication compliant with the Bluetooth (registered trademark) standard with the left controller 3 and with the right controller 4.

The processor 21 is connected to the left terminal 23 and the right terminal 22. When performing wired communication with the left controller 3, the processor 21 transmits data to the left controller 3 via the left terminal 23 and also receives operation data from the left controller 3 via the left terminal 23. Further, when performing wired communication with the right controller 4, the processor 21 transmits data to the right controller 4 via the right terminal 22 and also receives operation data from the right controller 4 via the right terminal 22. As described above, in the exemplary embodiment, the main body apparatus 2 can perform both wired communication and wireless communication with each of the left controller 3 and the right controller 4.

It should be noted that, in addition to the elements shown in FIG. 2, the main body apparatus 2 includes a battery that supplies power and an output terminal for outputting images and audio to a display device (e.g., a television) separate from the display 12.

### (Overview of Game)

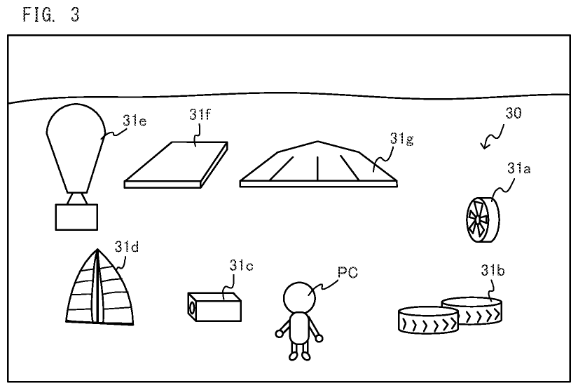

Next, a game according to the exemplary embodiment is described. FIG. 3 is a diagram showing an example of a game image displayed in a case where the game according to the exemplary embodiment is executed.

As shown in FIG. 3, the player character PC and a plurality of dynamic objects 31 (e.g., 31a to 31f) are placed on a ground 30 in a three-dimensional virtual space (a game space). Although not shown in FIG. 3, non-player characters (e.g., an enemy character, a company character of the player character PC, and the like) controlled by the processor 21 are placed in addition to the player character PC in the virtual space.

Based on an operation input provided to the controller (3 or 4), the player character PC moves in the virtual space or performs any of a plurality of actions in the virtual space.

For example, based on a direction operation input to the analog stick 6L of the controller 3, the player character PC moves on the ground 30 in the virtual space.

The player character PC performs an attack action as one of the plurality of actions. Specifically, the player character PC is equipped with a weapon object owned by the player character PC, and based on an operation input provided by the player, performs an attack action relating to the weapon object with which the player character PC is equipped. For example, the player character PC can perform an attack action using a proximity weapon object (e.g., a sword object) and an attack action using a remote weapon object (e.g., an arrow object).

The player character PC also performs an object operation action as one of the plurality of actions. For example, the object operation action is the action of remotely operating a dynamic object 31 in front of the player character PC.

Specifically, based on an operation input provided by the player, any of the plurality of dynamic objects placed in the virtual space is set as a control target of the object operation action. Based on the object operation action, the control target is moved in the virtual space. Based on the object operation action, the orientation of the control target is also controlled. Based on the object operation action, the control target is also connected (linked) to another dynamic object placed in the virtual space and integrated with the other dynamic object. Consequently, an assembly object obtained by combining a plurality of dynamic objects is generated. An operation on each dynamic object 31 based on the object operation action will be described below.

Each dynamic object 31 is an object capable of moving in the virtual space. Each of the plurality of dynamic objects 31 has unique mass, shape, and characteristics. As shown in FIG. 3, for example, the plurality of dynamic objects 31 include a fan object 31a, a wheel object 31b, a rocket object 31c, a sail object 31d, a balloon object 31e, a board object 31f, and a wing object 31g.

Specifically, the fan object 31a is an object representing a fan. The fan object 31a has a non-operating state and an operating state, can continuously generate a wind in the virtual space when in the operating state, and can apply a force to an object (e.g., an enemy character) placed in the virtual space by the force of the wind, thereby flying the object. In the operating state, the fan object 31a also continuously generates a propulsive force in a direction opposite to the direction of the wind.

The wheel object 31b is an object representing a wheel. The wheel object 31b has a non-operating state and an operating state, rotates in a direction set in advance when in the operating state, and continuously generates a propulsive force by the rotation.

The rocket object 31c is an object representing a rocket. The rocket object 31c has a non-operating state and an operating state. If the rocket object 31c enters the operating state, the rocket object 31c generates a strong propulsive force in a direction set in advance for a predetermined period (e.g., 10 seconds). If the predetermined period elapses after the rocket object 31c enters the operating state, the rocket object 31c disappears.

The sail object 31d is an object representing a sail. The sail object 31d is also an object that receives a wind blowing in the virtual space or a wind from the fan object 31a and generates a propulsive force. Although the details will be described below, for example, the sail object 31d forms a ship object by being connected to the board object 31f and generates a propulsive force for the ship object.

The balloon object 31e is an object representing a hot-air balloon and is an object capable of flying in the virtual space. The balloon object 31e has a non-operating state and an operating state and continuously generates a propulsive force upward in the virtual space when in the operating state. The propulsive force of the balloon object 31e differs in accordance with the magnitude of the heat.

The board object 31f is a planar object, and for example, can be used as the body of a vehicle. The board object 31f can also be used as a part of a ship object by putting the board object 31f on a water surface.

The wing object 31g is an object for flying in the sky. If the wing object 31g moves in the virtual space at a predetermined velocity or more, the wing object 31g generates a lift force upward in the virtual space.

Each of the fan object 31a, the wheel object 31b, the rocket object 31c, and the balloon object 31e is a dynamic object that generates a propulsive force itself when in the operating state, and can move in the virtual space by the propulsive force. For example, the sail object 31d receives a wind generated by the fan object 31a, a wind generated by another object, or a wind blowing in the virtual space and generates a propulsive force. These dynamic objects (31a to 31e) that generate a propulsive force are collectively referred to as “propulsive objects”.

On the other hand, each of the board object 31f and the wing object 31g is an object that does not have a non-operating state and an operating state, and is an object that does not generate a propulsive force. For example, if the wing object 31g moves at a predetermined velocity or more in the virtual space by another object applying a force to the wing object 31g, the wing object 31g generates a lift force, but the wing object 31g does not generate a propulsive force itself. The board object 31f can move in the virtual space by another object applying a force to the board object 31f, but the board object 31f does not generate a propulsive force itself. These dynamic objects (31d and 31f) that do not generate a propulsive force themselves are collectively referred to as “non-propulsive objects”. Each of the non-propulsive objects can move in the virtual space by receiving a force from a propulsive object, the player character PC, or a non-player character.

In the virtual space, a static object that does not move based on the action of the player character PC or the interaction between the static object and another object is also placed. Examples of the static object include terrain objects such as a rock, a mountain, a building, a ground, a river, and a sea fixed to the virtual space. The static object is an object that cannot be operated based on the object operation action.

(Operation on Dynamic Object Based on Object Operation Action) As described above, in the game according to the exemplary embodiment, it is possible to move a dynamic object 31 based on the object operation action of the player character PC. It is also possible to generate an assembly object by linking a plurality of dynamic objects 31 based on the object operation action.

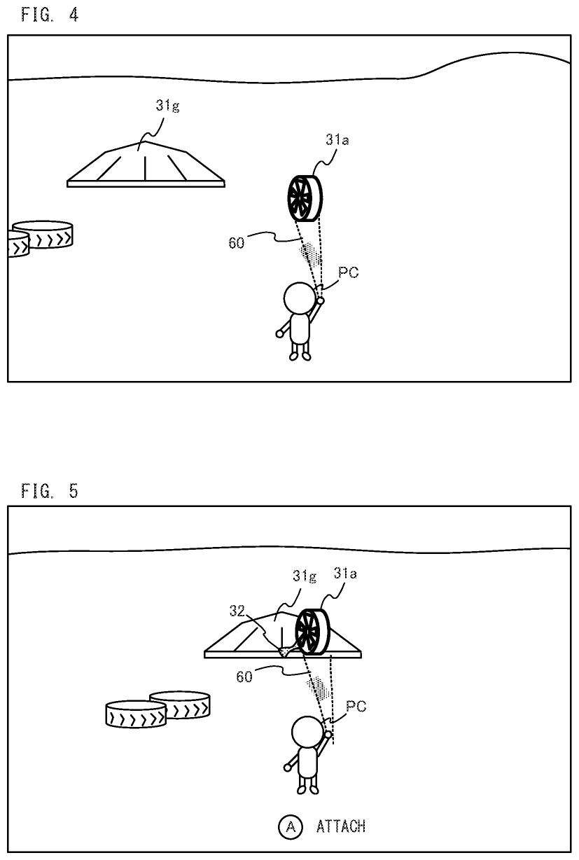

FIG. 4 is a diagram showing an example of a game image displayed when a dynamic object 31 is being operated based on the object operation action of the player character PC.

For example, when a dynamic object 31 is in front of the player character PC (or near the fixation point of a virtual camera), and if a predetermined operation input is provided, the player character PC performs the object operation action on the dynamic object 31. For example, in accordance with a predetermined selection operation, the fan object 31a is selected among the plurality of dynamic objects 31 placed in the virtual space. Then, if a predetermined operation input is provided, as shown in FIG. 4, the selected fan object 31a becomes a control target, and the game enters the state where the object operation action is being performed on the control target. In the state where the object operation action is being performed on the fan object 31a, the fan object 31a is in the state where the fan object 31a is off the ground, and is also in a display form different from normal. An effect image 60 indicating that the object operation action is being performed is also displayed.

At this time, if the player character PC moves in accordance with a movement operation input (e.g., a direction operation input to the analog stick 6L of the left controller 3) provided by the player, the fan object 31a also moves. For example, if a direction operation input is provided to the analog stick 6R of the right controller 4, the direction of the player character PC may change, and the fan object 31a may also move in the virtual space so that the fan object 31a is located in front of the player character PC. For example, the fan object 31a may be moved without the movement of the player character PC or rotated in accordance with key operations on the buttons 5L without a change in the direction the player character PC.

FIG. 5 is a diagram showing an example of a game image displayed when the fan object 31a is being moved based on the object operation action. As shown in FIG. 5, for example, while the fan object 31a is being operated based on the object operation action, and if the player character PC moves toward the wing object 31g, the fan object 31a also moves in the same direction by following the player character PC. Alternatively, while the fan object 31a is being operated based on the object operation action, the fan object 31a may move toward the wing object 31g in accordance with key operations on the buttons 5L. In a case where the fan object 31a and the wing object 31g satisfy a predetermined connection condition (e.g., the distance between the fan object 31a and the wing object 31g is less than a threshold), a connection object 32 suggesting a connection position is displayed (FIG. 5). When the connection object 32 is displayed, and if a connection instruction (e.g., the pressing of the A-button) is given by the player, the fan object 31a is connected (linked) to the wing object 31g. Consequently, an assembly object including a plurality of dynamic objects 31 is generated. Here, as the assembly object, an airplane object 40 including the fan object 31a and the wing object 31g is generated.

FIG. 6 is a diagram showing an example of the assembly object generated based on the object operation action and an example of the airplane object 40 including the fan object 31a and the wing object 31g.

As shown in FIG. 6, a connection object 32 is placed between the fan object 31a and the wing object 31g. The connection object 32 is an object indicating that the dynamic objects 31 are connected together and the connection position of the dynamic objects 31, and is an object that fixes the positional relationship between the dynamic objects 31. The plurality of dynamic objects 31 included in the assembly object are connected together by connection objects 32.

The assembly object including the plurality of dynamic objects 31 performs an action in a unified manner in the virtual space. For example, if the fan object 31a included in the airplane object 40 changes from the non-operating state to the operating state, the fan object 3 la generates a propulsive force. This propulsive force of the fan object 31a is also transmitted via the connection object 32 to the wing object 31g connected to the fan object 31a, and the airplane object 40 including the fan object 31a and the wing object 31g starts moving.

After the airplane object 40 starts moving, and when the velocity of the airplane object 40 exceeds a predetermined value, the airplane object 40 floats in the air by the lift of the wing object 31g and flies in the virtual space. The player character PC can fly in the virtual space on the airplane object 40.

(Control over Propulsive Force)

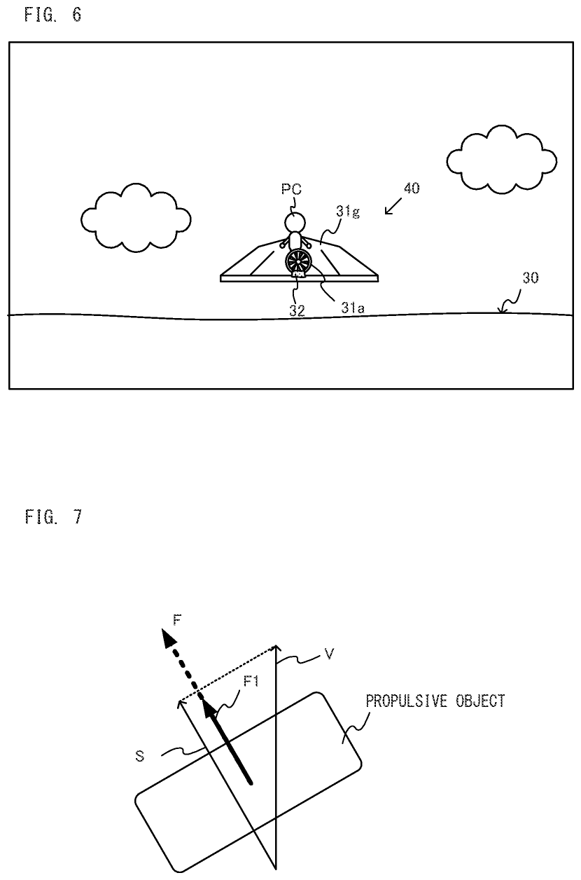

Next, control over the propulsive force of a propulsive object is described. FIG. 7 is a diagram illustrating control over the propulsive force of a propulsive object when the propulsive object is moving.

As described above, in the game according to the exemplary embodiment, the player can generate an assembly object by combining a plurality of dynamic objects 31. The assembly object can move in the virtual space. For example, FIG. 7 shows the moving direction and the direction of the propulsive force of a propulsive object (e.g., the fan object 31a) included in an assembly object.

As shown in FIG. 7, the propulsive object is moving at a velocity V (a velocity vector V) in the up direction in FIG. 7. The propulsive object generates a propulsive force F in a predetermined direction. In FIG. 7, the direction of the propulsive force F of the propulsive object is a left oblique upward direction and has a predetermined angle with the velocity V. Here, a component of the velocity V of the propulsive object along the direction of the propulsive force F is a propulsive force direction component S. The propulsive force direction component S is a three-dimensional vector. The propulsive force F of the propulsive object is changed in accordance with the magnitude of the propulsive force direction component S.

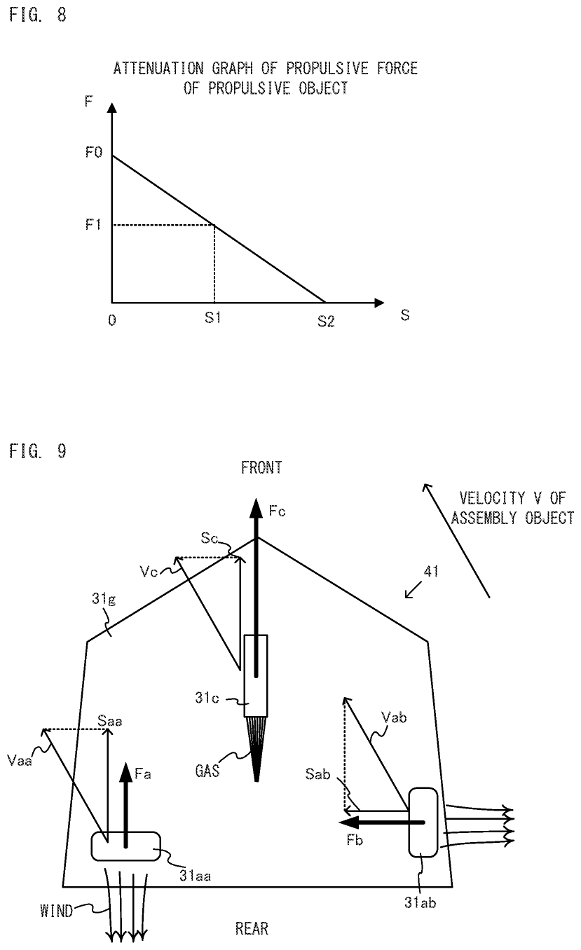

FIG. 8 is a diagram showing the relationship between the magnitude of the propulsive force direction component S of the velocity of the propulsive object and the magnitude of the propulsive force F.

As shown in FIG. 8, the propulsive force F of the propulsive object is attenuated in accordance with the magnitude of the propulsive force direction component S. For example, if the magnitude of the propulsive force direction component S is zero, the magnitude of the propulsive force F of the propulsive object is set to F0, which is the maximum value. The magnitude of the propulsive force F of the propulsive object is linearly attenuated in accordance with the magnitude of the propulsive force direction component S. For example, if the magnitude of the propulsive force direction component S is S1, the magnitude of the propulsive force F of the propulsive object is set to F1. FIG. 7 shows the state where the magnitude of the propulsive force F is attenuated to F1. Then, when the magnitude of the propulsive force direction component S exceeds S2, the magnitude of the propulsive force F is set to zero. The magnitude of the propulsive force F of the propulsive object is set in accordance with the magnitude of the propulsive force direction component S at the current moment. Thus, for example, while the magnitude of the propulsive force direction component S increases from zero to S2, the magnitude of the propulsive force F decreases from the maximum value to zero. Then, if the magnitude of the propulsive force direction component S turns downward and falls below S2, the magnitude of the propulsive force F increases and is set to a value relating to the magnitude of the propulsive force direction component S at that time.

If the propulsive force F is not attenuated, the propulsive object continues to accelerate, and the propulsive object is likely to reach a velocity beyond a range that can be accepted in the game. In the exemplary embodiment, the propulsive force F is attenuated in accordance with the propulsive force direction component S of the velocity V of the propulsive object, and if the propulsive force direction component S increases to a predetermined reference, the propulsive force F is controlled to become zero. Consequently, it is possible to prevent a propulsive object from continuing to accelerate and reaching a velocity beyond a range that can be accepted in the game.

In accordance with the type of the propulsive object, the relationship between the magnitude of the propulsive force direction component S of the velocity V and the magnitude of the propulsive force F of the propulsive object shown in FIG. 8 is set. That is, in accordance with the type of the propulsive object, the slope of the straight line shown in FIG. 8 differs, the value of F when S=0 differs, and the value of S when F=0 differs. For example, for a propulsive object for which a great propulsive force is set in advance (e.g., the rocket object 31c), the value of the propulsive force direction component S with which the propulsive force is zero is set to be great.

Both in a case where the propulsive object is included in an assembly object and in a case where the propulsive object is a sole propulsive object, the propulsive force of the propulsive object is attenuated in accordance with the propulsive force direction component S of the velocity V of the propulsive object.

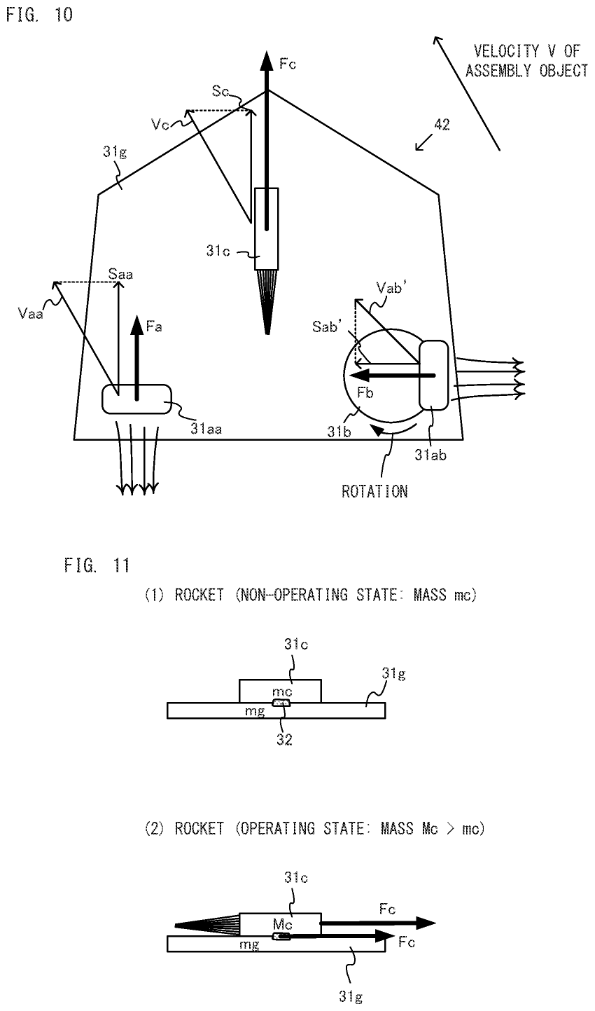

If a plurality of propulsive objects are included in an assembly object, a propulsive force is set with respect to each propulsive object. FIG. 9 is a diagram showing an example of an assembly object including the wing object 31g and a plurality of propulsive objects and is a diagram showing an example of control over the propulsive force of each propulsive object. FIG. 9 shows a diagram of the wing object 31g as viewed from above. The up direction in FIG. 9 is the front direction of the wing object 31g.

As shown in FIG. 9, a first fan object 31aa, a second fan object 31ab, and the rocket object 31c are connected as the plurality of propulsive objects onto the wing object 31g of an assembly object 41. Each of the plurality of propulsive objects (31aa, 31ab, and 31c) is in the operating state and is generating a propulsive force. By the propulsive force of each propulsive object, the assembly object 41 is accelerated in the virtual space and is moving at the velocity V at a certain time.

Specifically, the first fan object 31aa is placed in a rear left portion of the wing object 31g. The first fan object 31aa is generating a wind in the rear direction of the wing object 31g and generating a propulsive force Fa in the front direction of the wing object 31g. The second fan object 31ab is placed in a rear right portion of the wing object 31g. The second fan object 31ab is generating a wind to the right side with respect to the front direction of the wing object 31g and generating a propulsive force Fb to the left side with respect to the front direction of the wing object 31g. The rocket object 31c is placed in an approximately central portion of the wing object 31g. The rocket object 31c is discharging gas in the rear direction of the wing object 31g and generating a propulsive force Fc in the front direction of the wing object 31g.

By the propulsive forces of these three propulsive objects, the assembly object 41 is moving at the velocity V in the front direction and the left direction of the wing object 31g. The propulsive force of each propulsive object of this assembly object 41 is attenuated in accordance with the propulsive force direction component S. Specifically, the first fan object 31aa is moving at a velocity Vaa in the virtual space, and the propulsive force Fa is attenuated in accordance with a component (a propulsive force direction component) Saa of the velocity Vaa along the direction of the propulsive force Fa. The second fan object 31ab is moving at a velocity Vab in the virtual space, and the propulsive force Fb is attenuated in accordance with a component (a propulsive force direction component) Sab of the velocity Vab along the direction of the propulsive force Fb. The rocket object 31c is moving at a velocity Vc in the virtual space, and the propulsive force Fc is attenuated in accordance with a component (a propulsive force direction component) Sc of the velocity Vc along the direction of the propulsive force Fc.

In game processing according to the exemplary embodiment, physical calculations (calculations based on the laws of physics) are made on objects (the dynamic objects 31, the player character PC, and the like) at predetermined frame time intervals, whereby the velocity, the angular velocity, the position, the orientation, and the like of each object are calculated. Specifically, physical calculations are made based on the propulsive force of a propulsive object, another force (a lift force, a buoyant force, gravity, or the like) generated by each object, the interaction (a force to be received and a force to be applied) due to contact between objects, and the like, and the latest velocity, angular velocity, position, orientation, and the like of each object are calculated.

Each propulsive object shown in FIG. 9 is fixed onto the wing object 31g, and the velocity V of the assembly object 41, the velocity Vaa of the first fan object 31aa, the velocity Vab of the second fan object 31ab, and the velocity Vc of the rocket object 31c are the same as each other. Even if a plurality of propulsive objects are included in the same assembly object, the velocities of the plurality of propulsive objects may be different from each other.

FIG. 10 is a diagram showing an example of an assembly object including the wing object 31g and a plurality of propulsive objects and is a diagram showing a case where the velocities of the propulsive objects are different from each other.

Similarly to the assembly object 41 shown in FIG. 9, an assembly object 42 shown in FIG. 10 includes the first fan object 31aa, the second fan object 31ab, the rocket object 31c, and the wing object 31g. The assembly object 42 further includes the wheel object 31b. Specifically, the wheel object 31b is rotatably connected onto the wing object 31g. As shown in FIG. 10, the wheel object 31b rotates about an axis perpendicular to an upper surface of the wing object 31g when in the operating state. The second fan object 31ab is connected to the wheel object 31b.

In the state shown in FIG. 10, similarly to FIG. 9, the assembly object 42 is moving at the velocity V. The first fan object 31aa and the rocket object 31c are directly fixed to the wing object 31g, and the positional relationships between the first fan object 31aa, the rocket object 31c, and the wing object 31g do not change even while the assembly object 42 is moving. Thus, the first fan object 31aa and the rocket object 31c move at the same velocity V as that of the assembly object 42 (the wing object 31g). On the other hand, the second fan object 31ab is fixed to the wheel object 31b that rotates. Thus, the second fan object 31ab rotates in the assembly object 42, and the velocity of the rotation is added to the velocity V of the assembly object 42. That is, the second fan object 31ab moves in the virtual space at a velocity Vab′ obtained by adding the rotational velocity of the wheel object 31b to the velocity V of the assembly object 42. The propulsive force Fb of the second fan object 31ab is attenuated in accordance with the magnitude of a propulsive force direction component Sab′ of the velocity Vab′.

### (Descriptions of Propulsive Objects)

Each propulsive object has a different feature according to the type of the propulsive object. The details of the propulsive objects are described.

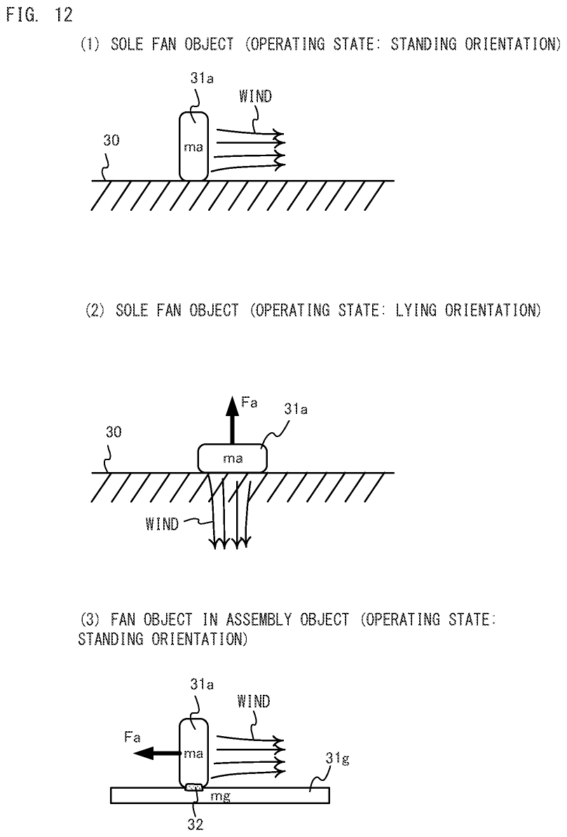

FIG. 11 is a diagram showing a behavior relating to the state of the rocket object 31c.

As shown in FIG. 11, the rocket object 31c has mass mc when in the non-operating state. If the rocket object 31c enters the operating state in this state, the mass of the rocket object 31c increases from mc to Mc (>mc) ((2) of FIG. 11). If the rocket object 31c enters the operating state, the inertia tensor of the rocket object 31c also increases compared to the non-operating state.

In an assembly object including the rocket object 31c and the wing object 31g, the mass of the entirety of the assembly object is mg+mc when the rocket object 31c is in the non-operating state. If the wing object 31g moves in the virtual space at a predetermined velocity or more, the wing object 31g generates a lift force. When this lift force exceeds (mg+mc), the assembly object floats and flies in the virtual space.

When the rocket object 31c is in the operating state, the mass of the rocket object 31c is increased to Mc. Consequently, the rocket object 31c generates a great propulsive force Fc, the propulsive force Fc is applied to the wing object 31g, and a great force is applied to the assembly object including the rocket object 31c and the wing object 31g. As described above, the propulsive force Fc is attenuated in accordance with the propulsive force direction component S of the velocity of the rocket object 31c.

When the rocket object 31c is in the operating state, the mass of the rocket object 31c is increased to Mc, whereby it is possible to apply a great force to a dynamic object 31 connected to the rocket object 31c. For example, when the rocket object 31c is in the operating state, and if the mass mc remains the same, it is possible to generate only a propulsive force fc=mc·α (α is an acceleration). On the other hand, when the rocket object 31c enters the operating state, the mass is increased to Mc (>mc), whereby it is possible to generate the propulsive force Fc=Mc·α (>fc).

As described above, when the rocket object 31c in the operating state, the mass and the inertia tensor of the rocket object 31c are increased compared to when the rocket object 31c is in the non-operating state. Consequently, when the rocket object 31c enters the operating state, it is possible to apply a great force to a dynamic object 31 connected to the rocket object 31c. Even in a case where the mass of the rocket object 31c is increased from mc to Mc, an increase in the gravity applied to the rocket object 31c is reduced and is set to be the same as that when the mass is mc, for example. If the gravity applied to the rocket object 31c is increased, the gravity applied to the rocket object 31c may be greater than a lift force generated by the wing object 31g, and for example, the assembly object including the rocket object 31c and the wing object 31g may fall. In the exemplary embodiment, however, even if the mass of the rocket object 31c is increased, the gravity is not increased (or an increase in the gravity is reduced). Thus, it is possible to prevent the assembly object including the rocket object 31c and the wing object 31g from falling by its own weight.

If a predetermined period (e.g., 10 seconds) elapses after the rocket object 31c enters the operating state, the rocket object 31c disappears (the rocket object 31c disappears from the virtual space, and the mass of the rocket object 31c also becomes zero). As described above, the rocket object 31c is in the operating state for the predetermined period and generates a great propulsive force. If the predetermined period elapses after the rocket object 31c enters the operating state, the rocket object 31c may enter the non-operating state, but may continue to be present without disappearing. In this case, the mass of the rocket object 31c is returned to mc.

Next, the fan object 31a is described. FIG. 12 is a diagram showing a behavior relating to the state of the fan object 31a.

As shown in FIG. 12, if the sole fan object 31a that is not a part of an assembly object enters the operating state in a standing orientation, the fan object 31a generates a wind in a predetermined direction, but does not generate a propulsive force ((1) of FIG. 12). The fan object 31a has mass ma. If the fan object 31a generates a propulsive force in the standing orientation, the fan object 31a may rotate due to friction with the ground 30 and fall over. Thus, even if the sole fan object 31a enters the operating state in the standing orientation, the fan object 31a does not generate a propulsive force. The fan object 31a maintains the operating state until the fan object 31a is set to the non-operating state. That is, the sole fan object 31a continues to generate the wind in the predetermined direction while maintaining the standing orientation.

If, on the other hand, the sole fan object 31a enters the operating state in a lying orientation, the fan object 31a generates a wind in a predetermined direction and also generates the propulsive force Fa in a direction opposite to the direction of the wind ((2) of FIG. 12). For example, in a case where the fan object 31a is placed in the lying orientation in the virtual space so that the propulsive force Fa is upward, and if the fan object 31a enters the operating state, the fan object 31a flies in the up direction by the propulsive force Fa of the fan object 31a itself. As described above, the propulsive force Fa is attenuated in accordance with the propulsive force direction component S of the velocity of the fan object 31a.

In a case where the fan object 31a is included in an assembly object, and when the fan object 31a is in the standing orientation and in the operating state, the fan object 31a generates a wind in a predetermined direction and also generates the propulsive force Fa ((3) of FIG. 12). The fan object 31a included in the assembly object generates a wind and also generates the propulsive force Fa in any orientation when in the operating state. The mass of the fan object 31a is not increased as in the rocket object 31c. As described above, the propulsive force Fa is attenuated in accordance with the propulsive force direction component S of the velocity of the fan object 31a.

Contrary to (2) of FIG. 12, if the sole fan object 31a is placed in the lying orientation so that the direction of the wind is upward, the fan object 31a may or may not generate the propulsive force Fa.

### (Movement by Propulsive Force of Sail Object)

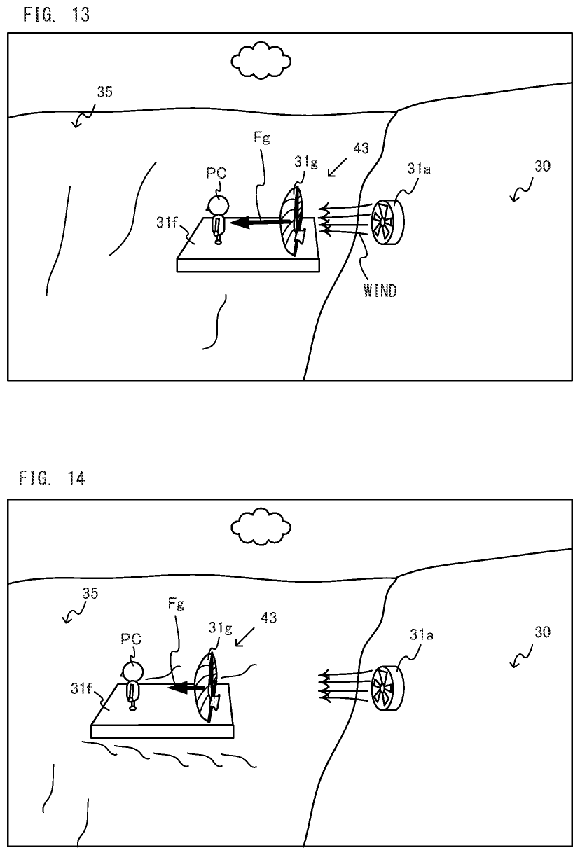

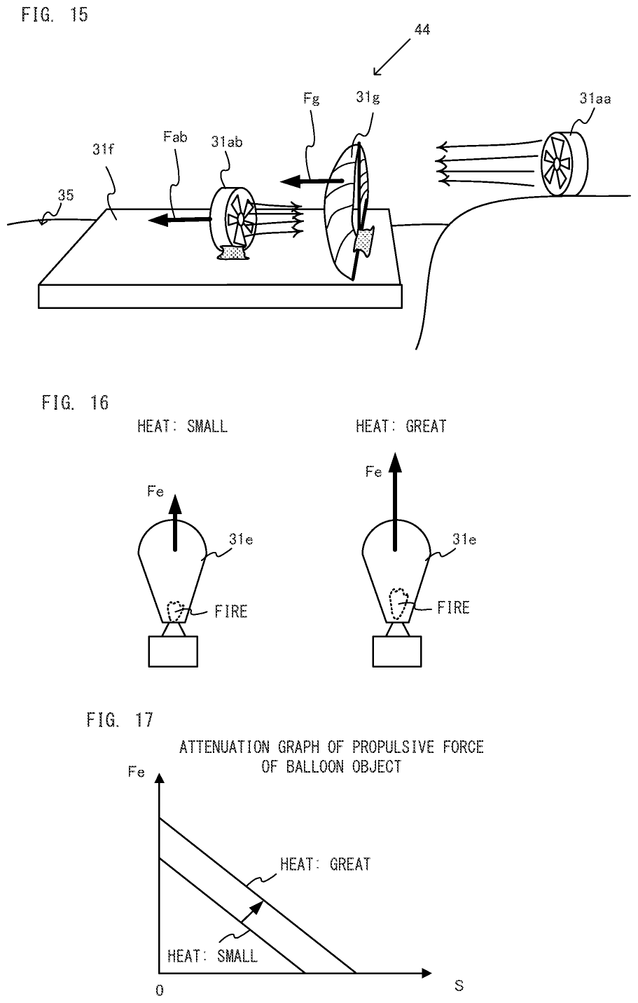

Next, the sail object 31d is described. FIG. 13 is a diagram showing an example of a game image displayed when an assembly object including the sail object 31d moves. FIG. 14 is a diagram showing an example of a game image displayed after a predetermined time elapses after the state of FIG. 13.

As shown in FIG. 13, a water surface 35 is set as an example of a terrain object in the virtual space. The player can generate an assembly object for moving on the water surface 35 by the above object operation action.

For example, as shown in FIG. 13, the player generates an assembly object 43 by connecting (linking) the sail object 31g onto the board object 31f. If the board object 31f is placed on the water surface 35, the board object 31f generates a buoyant force. If the gravity of objects mounting the board object 31f (the sail object 31g and the player character PC) is smaller than the buoyant force of the board object 31f, the board object 31f floats on the water surface 35. The sail object 31g also receives a wind and generates a propulsive force. For example, the player places the fan object 31a in the standing orientation near the boundary between the water surface 35 and the ground 30. The player brings the fan object 31a into the operating state in this state. For example, if the attack action of the player character PC hits the fan object 31a, the fan object 31a changes from the non-operating state to the operating state. The fan object 31a generates a wind in the operating state.

More specifically, in the left direction of the fan object 31a in FIG. 13, a predetermined contact determination area is generated. This contact determination area is an object having a predetermined shape for determining whether or not the wind hits an object, and is a three-dimensional object used in internal processing. The contact determination area is not displayed on the screen. Instead, when the contact determination area is generated, an effect image indicating that the wind blows may be displayed. A contact determination between this contact determination area and an object is made. If the contact determination area hits an object, a force is applied to the object. Physical calculations are made based on this force, whereby the behavior of the object when the wind hits the object is determined.

As shown in FIG. 13, if the wind (the contact determination area) from the fan object 31a hits the sail object 31g, the sail object 31g generates a propulsive force Fg. By the propulsive force Fg, the assembly object 43 including the sail object 31g and the board object 31f moves in the left direction on the water surface (FIG. 14). Consequently, the player character PC can move on the water surface while mounting the assembly object 43. As described above, the propulsive force Fg is attenuated in accordance with the propulsive force direction component S of the velocity of the sail object 31g.

If the fan object 31a is in the operating state, the contact determination area is continuously placed, but the range of the contact determination area is limited. The further away the contact determination area is from the fan object 31a, the smaller the size of the contact determination area may be, or the weaker the propulsive force when the contact determination area hits the sail object 31g may be. If the assembly object 43 is a predetermined distance or more away from the fan object 31a, the contact determination area does not hit the sail object 31g, and the sail object 31g does not generate a propulsive force. Thus, the assembly object 43 loses its propulsive force and stops on the water surface 35.

FIG. 15 is a diagram showing an example of an assembly object 44 including the second fan object 31ab, the sail object 31g, and the board object 31f.

As shown in FIG. 15, the second fan object 31ab and the sail object 31g are connected onto the board object 31f of the assembly object 44. Similarly to FIG. 13, the first fan object 31aa is placed in the standing orientation near the boundary between the water surface 35 and the ground 30. The player brings the first fan object 31aa on the ground 30 into the operating state in this state and further brings the second fan object 31ab in the assembly object 44 into the operating state. In this case, the second fan object 31ab generates a propulsive force Fab in the left direction in FIG. 15, and the sail object 31g also generates the propulsive force Fg in the left direction. Consequently, two propulsive forces are applied to the assembly object 44, and the assembly object 44 starts moving on the water surface 35 with a greater acceleration. Even if the assembly object 44 moves away from the first fan object 31aa to a distance at which the assembly object 44 is not influenced by a wind from the first fan object 31aa, the assembly object 44 can uninterruptedly continue to move by the propulsive force of the second fan object 31ab.

Here, as shown in FIG. 15, even if the sail object 31g is placed in the direction of a wind generated by the second fan object 31ab included in the assembly object 44, the sail object 31g does not generate a propulsive force due to the fact that the wind from the second fan object 31ab hits the sail object 31g. That is, if a contact determination area from the first fan object 31aa that is not included in the assembly object 44 hits the sail object 31g, the sail object 31g generates a propulsive force in the direction in which the contact determination area flies (the direction of the wind), but if a contact determination area from the second fan object 31ab included in the assembly object 44 hits the sail object 31g, the sail object 31g does not generate a propulsive force.

If the sail object 31g forming a part of the assembly object 44 generates a propulsive force in accordance with the fact that the contact determination area from the second fan object 31ab included in the same assembly object 44 hits the sail object 31g, the sail object 31g and the second fan object 31ab generate propulsive forces in directions opposite to each other. Alternatively, depending on the angle between the second fan object 31ab and the sail object 31g in the assembly object 44, the assembly object 44 may continue to rotate by the propulsive force of the second fan object 31ab and the propulsive force of the sail object 31g due to the wind from the second fan object 31ab. Thus, the player cannot move the assembly object 44 as intended. Thus, in the exemplary embodiment, if the fan object 31a and the sail object 31g are included in the same assembly object, the sail object 31g does not generate a propulsive force due to a contact determination area from the fan object 31a included in the same assembly object. Consequently, for example, it is possible to prevent the fan object 31a and the sail object 31g from generating propulsive forces in directions opposite to each other.

In FIG. 15, if either one of the second fan object 31ab and the sail object 31g is not connected to the board object 31f, the sail object 31g generates a propulsive force in accordance with the wind from the second fan object 31ab. For example, if the second fan object 31ab is not connected to the board object 31f and is simply mounting the board object 31f, the sail object 31g generates a propulsive force in accordance with the wind from the second fan object 31ab.

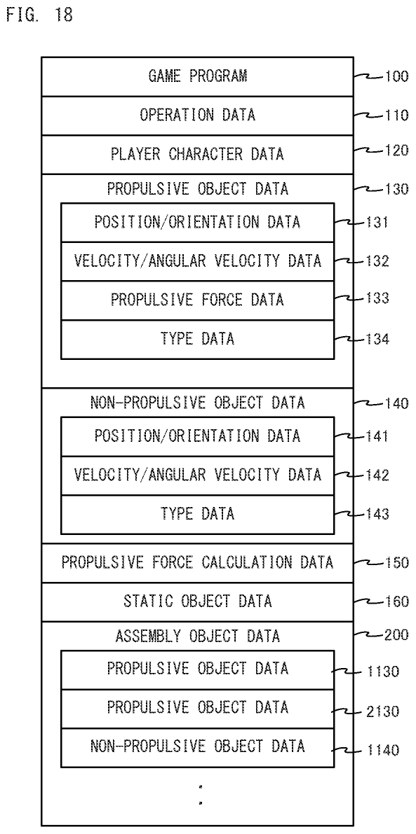

Next, the balloon object 31e is described. FIG. 16 is a diagram showing the difference between the direction of the propulsive force of the balloon object 31e and the propulsive force due to the heat. As shown in FIG. 16, the balloon object 31e generates a propulsive force Fe upward in the virtual space when in the operating state. Here, the balloon object 31e generates a different propulsive force Fe in accordance with the heat. For example, the player character PC can increase or decrease the heat of the balloon object 31e using an item (a predetermined parameter). The propulsive force Fe of the balloon object 31e differs in accordance with this heat.

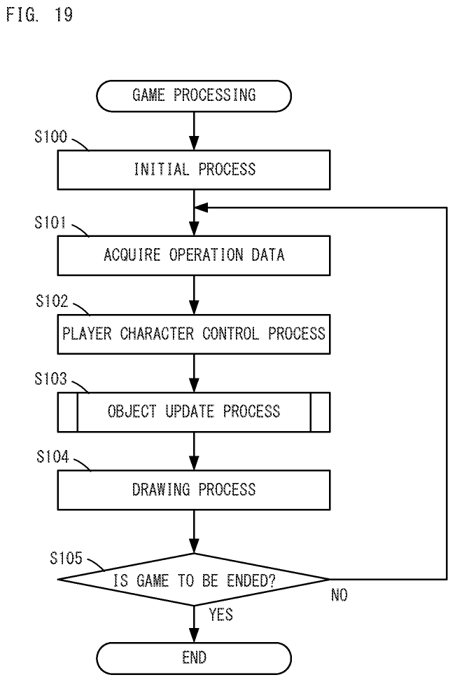

FIG. 17 is a diagram showing the relationship between the magnitude of the propulsive force direction component S of the velocity of the balloon object 31e and the magnitude of the propulsive force Fe. As shown in FIG. 17, an attenuation graph of the propulsive force differs between when the heat of the balloon object 31e is small and when the heat of the balloon object 31e is great. Specifically, the greater the heat of the balloon object 31e is, the more upper right in the graph a straight line indicating the relationship between the propulsive force direction component S and the propulsive force Fe is. For example, if the balloon object 31e is configured so that the heat of the balloon object 31e can be continuously changed using a predetermined game parameter owned by the player character PC, the straight line indicating the relationship between the propulsive force direction component S and the propulsive force Fe continuously moves to the upper right in the graph in accordance with an continuous increase in the heat.

Although not shown in the figures, similarly to the rocket object 31c, when the balloon object 31e is in the operating state, the mass and the inertia tensor of the balloon object 31e also increase compared to when the balloon object 31e is in the non-operating state. Consequently, when the balloon object 31e enters the operating state in an assembly object including the balloon object 31e and another dynamic object 31, it is possible to apply a great propulsive force to the assembly object.

As described above, in the game according to the exemplary embodiment, a plurality of types of dynamic objects 31 including a plurality of types of propulsive objects are placed in the virtual space. Based on the object operation action, the player can generate an assembly object by connecting (linking) a plurality of dynamic objects 31 and move the assembly object including a propulsive object. The propulsive object generates a propulsive force to move itself in a predetermined direction. The propulsive force F of the propulsive object is attenuated in accordance with the magnitude of the propulsive force direction component S so that the propulsive force F becomes zero when the propulsive force direction component S of the velocity of the propulsive object exceeds the predetermined reference. Consequently, it is possible to prevent the propulsive object from continuing to accelerate by the propulsive force and reaching a velocity beyond a range that can be accepted in the game. In a case where the player can freely generate an assembly object including a plurality of propulsive objects, each of the propulsive objects receives not only a propulsive force generated by the propulsive object itself, but also a force from another propulsive object due to the interaction between the objects, while the propulsive object applies a force to another object. Even in this case, the process of attenuating the propulsive force is performed on each of the propulsive objects, whereby it is possible to reduce the velocity of each of the propulsive objects in even in a complexly combined assembly object and control the action of the entirety of the assembly object.

Generally, for example, it is possible that in a case where a certain acceleration is applied to an object capable of moving in a game space and the object reaches a certain velocity, control for maintaining the velocity is performed. Such control is suitable in a case where a simple object set in advance is moved, but may not necessarily be able to be said to be suitable control in a case where an assembly object can be freely generated by combining a plurality of dynamic objects. That is, if simple control for, in a case where a certain acceleration is applied to an assembly object obtained by combining a plurality of dynamic objects and the assembly object reaches a certain velocity, maintaining the velocity is performed, the characteristics (the magnitude and the direction of the propulsive force of a propulsive object, and another force such as a lift force) of each of the dynamic objects included in the assembly object cannot be used, and only a simple behavior can be achieved. As in the exemplary embodiment, however, the propulsive force of each of propulsive objects included in an assembly object is attenuated in accordance with the propulsive force direction component S, whereby it is possible to control the entirety of the assembly object while using the effects of the characteristics and the placement of each of the propulsive objects. For example, in a case where many propulsive objects are connected to an assembly object, the velocity of the assembly object is limited due to the attenuation of the propulsive force of each of the propulsive objects, but it is possible to obtain effects due to an increase in the propulsive force, such as the effect that it is easy for the assembly object to accelerate, the effect that the assembly object is less likely to be influenced even by resistance generated due to the state of a terrain or by an obstacle.

### (Data Used in Game Processing)

Next, the details of game processing regarding the above game are described. First, data used in the game processing is described. FIG. 18 is a diagram showing an example of data stored in a memory of the main body apparatus 2 during the execution of the game processing.

As shown in FIG. 18, the memory (the DRAM 27, the flash memory 26, or the external storage medium) of the main body apparatus 2 stores a game program 100, operation data 110, player character data 120, propulsive object data 130, non-propulsive object data 140, propulsive force calculation data 150, static object data 160, and assembly object data 200. As well as these pieces of data, various pieces of data used in game processing (e.g., data regarding an enemy character and the like) are stored in the memory.

The game program 100 is a program for executing the game processing described below. The game program is stored in advance in the external storage medium attached to the slot 29 or the flash memory 26, and when the game is executed, is loaded into the DRAM 27. The game program may be acquired from another apparatus via a network (e.g., the Internet).

The operation data 110 is data transmitted from the left controller 3 and the right controller 4 to the main body apparatus 2. The controllers 3 and 4 repeatedly transmit the operation data 110 to the main body apparatus 2 at predetermined time intervals (e.g., 1/200-second intervals).

The player character data 120 is data regarding the player character PC. For example, the player character data 120 includes data regarding the position and the orientation of the player character PC and data regarding the velocity and the angular velocity of the player character PC. The player character data 120 also includes data indicating whether or not the player character PC is performing the object operation action.

The propulsive object data 130 is data regarding the propulsive objects among the dynamic objects placed in the virtual space. The propulsive object data 130 is stored with respect to each propulsive object placed in the virtual space. The propulsive object data 130 includes position/orientation data 131, velocity/angular velocity data 132, propulsive force data 133, and type data 134.

The position/orientation data 131 is data regarding the position and the orientation in the virtual space of the propulsive object. Specifically, the position/orientation data 131 includes data indicating the position and the orientation of the propulsive object in the latest frame and data indicating the position and the orientation of the propulsive object at least in in the immediately preceding frame.

The velocity/angular velocity data 132 is data regarding the velocity and the angular velocity in the virtual space of the propulsive object. Specifically, the velocity/angular velocity data 132 includes data indicating the velocity and the angular velocity of the dynamic object 31 in the latest frame and data indicating the velocity and the angular velocity of the propulsive object at least in the immediately preceding frame.

The propulsive force data 133 is data regarding the current propulsive force F of the propulsive object, and for example, is a three-dimensional vector indicating the magnitude and the direction of the propulsive force F. The direction of the propulsive force Fis set in accordance with the orientation of the propulsive object. The magnitude of the propulsive force F is set in accordance with the propulsive force direction component S of the velocity of the propulsive object.

The type data 134 is data indicating the type of the propulsive object. For example, the type data 134 includes data regarding the shape and the external appearance of the propulsive object, data regarding the mass of the propulsive object, data indicating whether the propulsive object is in the operating state or in the non-operating state, and data regarding the behavior of the propulsive object in a case where the propulsive object is in the operating state (e.g., data regarding the magnitude of the propulsive force, the direction of the propulsive force, and the like).

The non-propulsive object data 140 is data regarding the non-propulsive objects among the dynamic objects 31 placed in the virtual space. The non-propulsive object data 140 is stored with respect to each non-propulsive object placed in the virtual space. The non-propulsive object data 140 includes position/orientation data 141 regarding the position and the orientation of the non-propulsive object, velocity/angular velocity data 142 regarding the velocity and the angular velocity of the non-propulsive object, and type data 143. The type data 143 is data indicating the type of the non-propulsive object and includes data regarding the shape and the external appearance of the non-propulsive object, data regarding the mass of the non-propulsive object, other characteristics (e.g., generating a lift force in accordance with the velocity and generating a buoyant force on a water surface), and the like.

The propulsive force calculation data 150 is data indicating the relationship between the magnitude of the propulsive force direction component S of the velocity of a propulsive object and the magnitude of the propulsive force F (e.g., a formula representing the graph shown in FIG. 8). The propulsive force calculation data 150 is prepared with respect to each type of propulsive object.

The static object data 160 is data regarding the static objects placed in the virtual space (objects representing a rock, a mountain, a building, a ground, and the like fixed to the virtual space). The static object data 160 is stored with respect to each static object. The static object data 160 includes data regarding the position and the orientation of the static object, data regarding the type of the static object, and data regarding the shape and the external appearance of the static object.

The assembly object data 200 is data regarding assembly objects placed in the virtual space. The assembly object data 200 is stored with respect to each assembly object. The assembly object data 200 includes a plurality of pieces of propulsive object data (1130, 2130, and the like). The pieces of propulsive object data included in the assembly object data 200 have data similar to that of the propulsive object data 130. The assembly object data 200 also includes pieces of non-propulsive object data (e.g., 1140 and the like). The pieces of non-propulsive object data included in the assembly object data 200 have data similar to that of the non-propulsive object data 140.

Although not shown in the figures, the assembly object data 200 includes data indicating the position and the orientation in the assembly object of each of dynamic objects forming the assembly object and data indicating the connection positions of dynamic objects in the assembly object. The assembly object data 200 may also include data regarding the mass, the position of the center of gravity, the velocity, the angular velocity, and the like of the entirety of the assembly object.

### (Details of Game Processing)

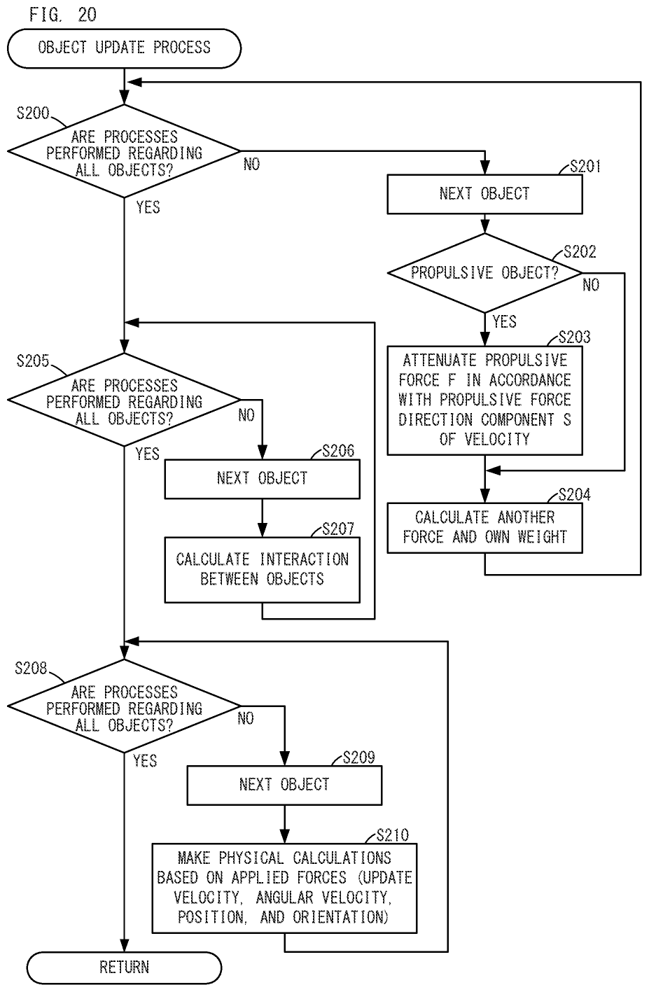

Next, the details of game processing performed by the main body apparatus 2 are described. FIG. 19 is a flow chart showing an example of game processing executed by the processor 21.

As shown in FIG. 19, if game processing is started, the processor 21 executes an initial process (step S100). Specifically, the processor 21 sets the three-dimensional virtual space and places the static objects (the terrain objects), the player character PC, the plurality of dynamic objects 31 (the plurality of propulsive objects and the plurality of non-propulsive objects), and a non-player character such as an enemy character in the virtual space.

Next, the processor 21 acquires operation data transmitted from the controllers and stored in the memory (step S101). The operation data includes data relating to operations on the buttons, the analog sticks, and the like of the left and right controllers. Hereinafter, the processor 21 repeatedly executes the processes of steps S101 to $105 at predetermined frame time intervals (e.g., 1/60 second intervals).

Subsequently, based on the operation data, the processor 21 performs a player character control process (step S102). Here, in accordance with an operation input provided to the controllers, the processor 21 controls the player character PC in the virtual space.

Specifically, in step S102, based on the operation data, for example, the movement of the player character PC is controlled, the player character PC performs an attack action, or the player character PC performs the object operation action.

For example, if a movement operation input (e.g., a direction operation input to the analog stick 6L) is given, in step S102, the processor 21 controls the movement of the player character PC.

If an operation input for an attack action is provided, in step S102, the processor 21 causes the player character PC to start an attack action. While the attack action of the player character PC is being executed, and if the attack action hits a propulsive object or an assembly object, the processor 21 changes the propulsive object hit by the attack action or all propulsive objects included in the assembly object hit by the attack action from the non-operating state to the operating state or from the operating state to the non-operating state. Here, for example, if the attack action hits the rocket object 31c or an assembly object including the rocket object 31c, the processor 21 increases the mass and the inertia tensor of the rocket object 31c. Also if the attack action hits the balloon object 31e or an assembly object including the balloon object 31e, similarly, the processor 21 increases the mass and the inertia tensor of the balloon object 31e.

In step S102, the processor 21 performs a process regarding the object operation action. Specifically, based on an operation input provided by the player, the processor 21 specifies a dynamic object placed in the virtual space, moves the specified dynamic object 31, rotates the specified dynamic object 31, or connects the specified dynamic object 31 to another dynamic object 31.

Next, the processor 21 performs an object update process (step S103). Here, the processor 21 makes physical calculations regarding objects (the dynamic objects 31, the player character PC, the non-player character, and the like) in the virtual space, thereby updating the velocity, the angular velocity, the position, the orientation, and the like of each object. The details of the object update process will be described below.

Next, the processor 21 performs a drawing process (step S104). Here, an image of the virtual space viewed from the virtual camera placed in the virtual space is generated. Consequently, a game image relating to the processes of steps S101 to S103 is generated. The generated game image is output to the display 12 or another display device. The drawing process in step S104 is repeatedly executed at predetermined frame time intervals, whereby the state where each dynamic object 31 moves, the player character PC moves, and the player character PC performs various actions in the virtual space is displayed.

Next, the processor 21 determines whether or not to end the game (step S105). For example, if the player gives an instruction to end the game, the processor 21 determines that the game is to be ended. Then, the processor 21 ends the game processing shown in FIG. 19. If, on the other hand, the determination is NO in step S105, the processor 21 executes the process of step S101 again.

### (Object Update Process)

FIG. 20 is a flow chart showing an example of the object update process in step S103.

As shown in FIG. 20, the processor 21 determines whether or not the processes of steps S201 to S204 are performed regarding all the objects placed in the virtual space (the dynamic objects 31, the player character, and the non-player character) in the currently process of FIG. 20 (step S200).

If the determination is NO in step S200, the processor 21 selects an object that has not yet been subjected to the processes as a processing target (step S201).

Next, the processor 21 determines whether or not the object as the processing target is a propulsive object (e.g., the dynamic objects 31a to 31e) (step S202).

If it is determined that the object as the processing target is a propulsive object (step S202: YES), the processor 21 attenuates the propulsive force F in accordance with the magnitude of the propulsive force direction component S of the velocity of the propulsive object as the processing target (step S203). Here, the processor 21 calculates the magnitude of the propulsive force to be generated by the propulsive object as the processing target. For each propulsive object, a propulsive force relating to the type of the propulsive object is set in advance, and the propulsive force set in advance is attenuated in accordance with the magnitude of the propulsive force direction component S of the current velocity of the propulsive object. Specifically, based on the velocity vector of the propulsive object updated in the previous frame that is stored in the velocity/acceleration data 132 and the direction of the propulsive force stored in the propulsive force data 133, the processor 21 calculates the propulsive force direction component S of the velocity of the propulsive object. Then, using data indicating the relationship between the magnitude of the propulsive force direction component S and the magnitude of the propulsive force F that is stored in the propulsive force calculation data 150, the processor 21 calculates the magnitude of the propulsive force F relating to the magnitude of the propulsive force direction component S. When the magnitude of the propulsive force direction component S exceeds the predetermined reference value set in accordance with the propulsive object, the processor 21 sets the propulsive force F of the propulsive object to zero. Regarding a propulsive object having an operating state and a non-operating state, even if the processor 21 sets the propulsive force F of the propulsive object to zero, the processor 21 maintains the propulsive object in the operating state.

For example, if the propulsive object as the processing target is the fan object 31a, and the fan object 31a is in the operating state, in step S203, the processor 21 attenuates the propulsive force in accordance with the propulsive force direction component S of the velocity of the fan object 31a. If the propulsive object as the processing target is the rocket object 31c, and the rocket object 31c is in the operating state, the processor 21 attenuates the propulsive force in accordance with the propulsive force direction component S of the velocity of the rocket object 31c. If the propulsive object as the processing target is the sail object 31d, the processor 21 determines whether or not a predetermined contact determination area (a wind from the fan object 31a or a wind blowing in the virtual space) hits the sail object 31d. If it is determined that the predetermined contact determination area hits the sail object 31d, the processor 21 causes the sail object 31d to generate a propulsive force. That is, the sail object 31d is an object having a property in which the object is expected to move by a wind. Thus, instead of an effect due to the force of a wind, the sail object 31d itself is caused to generate a propulsive force, thereby facilitating the understanding of the effect of a wind than in another object. If a propulsive force is generated by the sail object 31d, the processor 21 attenuates the propulsive force in accordance with the propulsive force direction component S of the velocity of the sail object 31d. Even if a contact determination area hits the sail object 31d, but if the contact determination area is generated by the fan object 31a included in the same assembly object as the sail object 31d, the processor 21 does not cause the sail object 31d to generate a propulsive force. That is, if a contact determination area except for a contact determination area generated by the fan object 31a included in the assembly object including the sail object 31d hits the sail object 31d, the processor 21 causes the sail object 31d to generate a propulsive force.

If the process of step S203 is executed, or if the determination is NO in step S202, the processor 21 calculates another force and the own weight regarding the object as the processing target (step S204). Here, the processor 21 calculates all forces generated by the object as the processing target other than the propulsive force (except for a force due to the interaction between objects in step S207 described below). For example, in a case where the object as the processing target generates a buoyant force or a lift force, the processor 21 calculates the buoyant force or the lift force. The processor 21 also calculates the gravity of the object as the processing target. The processor 21 also calculates a force to be received from the environment by the processing target.

If the process of step S204 is executed, the processor 21 executes the process of step S200 again.

If the determination is YES in step S200, the processor 21 determines whether or not the processes of steps S206 and S207 are performed regarding all the objects placed in the virtual space in the current process of FIG. 20 (step S205).

If the determination is NO in step S205, the processor 21 selects an object that has not yet been subjected to the processes as a processing target (step S206).

Next, the processor 21 calculates the interaction between the object as the processing target and another object (step S207). Here, in a case where the object as the processing target is in contact with another object, the processor 21 calculates a force to be received by the object as the processing target from the object with which the object as the processing target is in contact, and a force to be applied by the object as the processing target to the object with which the object as the processing target is in contact. In step S207, the interaction between dynamic objects 31, the interaction between a dynamic object 31 and the player character PC, the interaction between a dynamic object 31 and the non-player character, and the interaction between the player character PC and the non-player character are calculated. Forces relating to the fact that winds generated in the virtual space (a wind blowing in the virtual space, a wind from the fan object 31a, and the like; specifically, a contact determination area indicating a wind) hit an object are also calculated.

For example, if a dynamic object as a processing target is connected (linked) to another dynamic object, in step S207, the processor 21 calculates a force to act between these dynamic objects. The processor 21 also determines whether or not the object as the processing target and another object that is not connected to the object as the processing target are in contact with each other, and if it is determined that the object as the processing target and the other object are in contact with each other, the processor 21 calculates a force to act between these objects. For example, if the player character is mounting a dynamic object 31 as a processing target, the processor 21 calculates a force to act between these objects. For example, if a dynamic object 31 as a processing target collides with another dynamic object 31, the processor 21 calculates a force to act between these dynamic objects 31. The processor 21 also determines whether or not the object as the processing target comes into contact with a wind (a contact determination area) generated in the virtual space, and if it is determined that the object as the processing target comes into contact with a wind, the processor 21 applies a force relating to the contact with the contact determination area to the object as the processing target. If the object as the processing target is the sail object 31d, a propulsive force is generated in accordance with contact with a contact determination area in the above step S203, and therefore, a force relating to contact with a contact determination area may not be applied in step S207.

If the process of step S207 is executed, the processor 21 executes the process of step S205 again.

If the determination is YES in step S205, the processor 21 determines whether or not the processes of steps S209 and S210 are performed regarding all the objects placed in the virtual space in the current process of FIG. 20 (step S208).

If the determination is NO in step S208, the processor 21 selects an object that has not yet been subjected to the processes as a processing target (step S209).

Next, the processor 21 makes physical calculations based on the forces applied to the object as the processing target (step S210). Here, based on the forces applied to the object as the processing target (the forces calculated in S203, S204, and S207), the processor 21 makes physical calculations on the object as the processing target, thereby calculating the velocity, the angular velocity, the position, and the orientation of the object. Then, the processor 21 stores the velocity, the angular velocity, the position, and the orientation in the memory. For example, if the object as the processing target is a propulsive object, the processor 21 stores the calculated velocity and angular velocity as the velocity/angular velocity data 132 and stores the calculated position and orientation as the position/orientation data 131. If the object as the processing target is a non-propulsive object, the processor 21 stores the calculated velocity and angular velocity as the velocity/angular velocity data 142 and stores the calculated position and orientation as the position/orientation data 141. If the object as the processing target is the player character PC, the processor 21 stores the calculated velocity, angular velocity, position, and orientation as the player character data 120.

If the process of step S210 is executed, the processor 21 executes the process of step S208 again.

If the determination is YES in step S208, the processor 21 ends the process shown in FIG. 20.

As described above, in the game according to the above exemplary embodiment, the movement of a dynamic object is controlled in the virtual space based on physical calculations (S210). Among the dynamic objects, regarding a propulsive object that generates a propulsive force and moves based on the propulsive force, the propulsive force is attenuated in accordance with the moving velocity of the propulsive object so that the propulsive force becomes zero when the moving velocity of the propulsive object exceeds the predetermined reference (S203).

Consequently, it is possible to prevent a propulsive object from continuing to accelerate by a propulsive force and reaching a velocity beyond a range that can be accepted in the game.

In the above exemplary embodiment, based on an operation input, the player can form an assembly object by linking a plurality of dynamic objects. Regarding propulsive objects included in the assembly object, the propulsive force of each of the propulsive objects is attenuated in accordance with the velocity of the propulsive object. Consequently, regarding an assembly object that can be freely formed by the player, it is possible to attenuate the propulsive force of each of propulsive objects included in the assembly object and appropriately control the motion of the assembly object.

In the above exemplary embodiment, when a component of the velocity of a propulsive object along the direction of the propulsive force of the propulsive object exceeds the predetermined reference value, the propulsive force of the propulsive object is controlled to become zero. Consequently, even if the directions of the velocity of a propulsive object and the propulsive force of the propulsive object are different from each other, but when a component of the velocity of the propulsive object along the direction of the propulsive force of the propulsive object exceeds the predetermined reference value, it is possible to control the propulsive force to become zero.

In the above exemplary embodiment, the propulsive objects include the fan object 31a. The fan object 31a has an operating state and a non-operating state and continuously generates a propulsive force in a predetermined direction in the operating state. The propulsive force of the fan object 31a is attenuated in accordance with the propulsive force direction component S of the velocity of the fan object 31a. When the propulsive force direction component S exceeds the predetermined reference value, the propulsive force is set to zero even in the operating state.

In the above exemplary embodiment, in a case where the fan object 31a is not a part of an assembly object and is in a predetermined orientation (e.g., a standing orientation), the fan object 31a does not generate a propulsive force even in the operating state. Consequently, it is possible to prevent the fan object 31a from generating a propulsive force in a predetermined orientation, and for example, maintain the fan object 31a in the predetermined orientation.

In the above exemplary embodiment, the fan object 31a generates a contact determination area (an area for determining whether or not a wind hits an object) in the virtual space in addition to a propulsive force, and if the contact determination area comes into contact with the sail object 31d, the sail object 31d is caused to generate a propulsive force.

In the above exemplary embodiment, if a contact determination area except for a contact determination area generated by the fan object 31a included in an assembly object including the sail object 31d and the sail object 31d come into contact with each other, a propulsive force is generated in the sail object 31d. That is, if the second fan object 31ab and the sail object 31d are included in an assembly object (FIG. 15), the sail object 31d does not generate a propulsive force based on a contact determination area generated by the second fan object 31ab, and if the sail object 31d comes into contact with a contact determination area generated by the first fan object 31aa that is not included in the assembly object, the sail object 31d generates a propulsive force. Consequently, for example, it is possible to prevent propulsive forces that repel each other from being generated in the same assembly object.

In the above exemplary embodiment, the rocket object 31c among the propulsive objects generates a propulsive force for a predetermined period from a timing specified based on an operation input (e.g., the timing when the attack action of the player character PC hits the rocket object 31c). The rocket object 31c generates a propulsive force greater than that of another propulsive object. Consequently, it is possible to generate a great propulsive force in a short time. While the rocket object 31c is generating a propulsive force, the mass and the inertia tensor of the rocket object 31c used in physical calculations are increased. Consequently, if the rocket object 31c is included in an assembly object, it is possible to apply a great propulsive force to the assembly object.

In the above exemplary embodiment, the balloon object 31e among the propulsive objects generates a propulsive force in the up direction in the virtual space. The greater a predetermined parameter (e.g., the heat) applied based on the game processing is, the more increased the propulsive force of the balloon object 31e and the predetermined reference value for setting the propulsive force to zero are. While the balloon object 31e is generating a propulsive force, the mass and the inertia tensor of the balloon object 31e used in physical calculations are increased. Consequently, if the balloon object 31e is included in an assembly object, it is possible to apply a great propulsive force to the assembly object.

### (Variations)

While the exemplary embodiment has been described above, the exemplary embodiment is merely an example and may be modified as follows, for example.

For example, the processes shown in the above flow charts are merely illustrative, and the order and the contents of the processes, the thresholds used in the determinations, and the like may be appropriately changed.

In the above exemplary embodiment, when the propulsive force direction component S of the velocity of a propulsive object exceeds the predetermined reference, the propulsive force is set to zero. In another exemplary embodiment, when the propulsive force direction component S exceeds the predetermined reference, the propulsive force of the propulsive object may not be set to exactly zero so long as the propulsive force of the propulsive object becomes substantially zero.

In the above exemplary embodiment, the propulsive force F of a propulsive object is linearly decreased in accordance with an increase in the propulsive force direction component S of the velocity of the propulsive object. In another exemplary embodiment, the relationship between the propulsive force direction component S and the propulsive force F may be represented not by a straight line, but by a curve. A graph representing the relationship between the propulsive force direction component S and the propulsive force F may include a linear portion and a curved portion. The slope of a straight line or the shape of a curve representing the relationship between the propulsive force direction component S and the propulsive force F may differ in accordance with the scene of the game. For example, regarding a certain propulsive object, in a first scene of the game, the relationship between the propulsive force direction component S and the propulsive force F may be represented by a straight line, and in a second scene of the game, the relationship may be represented by a curve. A propulsive object regarding which the relationship between the propulsive force direction component S and the propulsive force F is represented by a straight line and a propulsive object regarding which the relationship between the propulsive force direction component S and the propulsive force F is represented by a curve may be prepared.

The propulsive objects described in the above exemplary embodiment are mere examples, and another propulsive object may be prepared.

In the above exemplary embodiment, an assembly object obtained by connecting a plurality of dynamic objects is generated based on the object operation action of the player character PC. In another exemplary embodiment, an assembly object may be generated not based on the action of the player character, but based on an operation of the player. An assembly object prepared in advance may be placed in the virtual space.

The configuration of the hardware that performs the above game processing is merely an example, and the above game processing may be performed by any other hardware. For example, the above game processing may be executed by any information processing system such as a personal computer, a tablet terminal, a smartphone, or a server on the Internet. The above game processing may also be executed in a dispersed manner by a plurality of apparatuses.

The configurations of the above exemplary embodiment and its variations can be optionally combined together unless they contradict each other. Further, the above description is merely an example of the exemplary embodiment, and may be improved and modified in various manners other than the above.

While certain example systems, methods, devices and apparatuses have been described herein, it is to be understood that the appended claims are not to be limited to the systems, methods, devices and apparatuses disclosed, but on the contrary, are intended to cover various modifications and equivalent arrangements included within the spirit and scope of the appended claims.

What is claimed is:

1. One or more non-transitory computer-readable media having stored therein instructions that, when executed, cause one or more processors of an information processing apparatus to execute game processing comprising:
controlling each of propulsive objects that generates a propulsive force and moves at least based on the propulsive force among dynamic objects which are placed in a virtual space and of which movements are controlled based on physical calculations:
attenuating the propulsive force of the propulsive object in accordance with a moving velocity of the propulsive object; and
when the moving velocity based on physical calculations exceeds a predetermined reference, controlling the propulsive force to be zero.

2. The one or more non-transitory computer-readable media according to claim 1, wherein
the game processing further comprises forming an assembly object by linking a plurality of the dynamic objects based on an operation input.

3. The one or more non-transitory computer-readable media according to claim 2, wherein
the game processing further comprises:
regarding each of the dynamic objects included in the assembly object, determining a moving velocity based on physical calculations using forces from the dynamic objects to which the dynamic object is linked; and
regarding each of the propulsive objects included in the assembly object, attenuating the propulsive force of the propulsive object in accordance with the moving velocity of the propulsive object.

4. The one or more non-transitory computer-readable media according to claim 1, wherein
the game processing further comprises attenuating the propulsive force in accordance with a component of the moving velocity along a direction of the propulsive force, and
the predetermined reference is that the component along the direction of the propulsive force reaches a predetermined reference value.

5. The one or more non-transitory computer-readable media according to claim 4, wherein
the game processing further comprises, for a first propulsive object having a first state and a second state among the propulsive objects, continuously generating the propulsive force in a predetermined direction in the first state.

6. The one or more non-transitory computer-readable media according to claim 5, wherein
the game processing further comprises, if the first propulsive object is not a part of an assembly object and is in a predetermined orientation, controlling the first propulsive object not to generate the propulsive force in the first state.

7. The one or more non-transitory computer-readable media according to claim 5, wherein
the propulsive objects include a second propulsive object, and
the game processing further comprises causing the first propulsive object to generate a contact determination area in the virtual space in addition to the propulsive force, and if the contact determination area comes into contact with the second propulsive object, causing the second propulsive object to generate the propulsive force.

8. The one or more non-transitory computer-readable media according to claim 7, wherein
the game processing further comprises, if the contact determination area except for the contact determination area generated by the first propulsive object included in an assembly object including the second propulsive object and the second propulsive object come into contact with each other, causing the second propulsive object to generate the propulsive force.

9. The one or more non-transitory computer-readable media according to claim 4, wherein
the game processing further comprises causing a third propulsive object among the propulsive objects to generate the propulsive force for a predetermined period from a timing specified based on an operation input.

10. The one or more non-transitory computer-readable media according to claim 9, wherein
the game processing further comprises, while the propulsive force is being generated in the third propulsive object, increasing mass and an inertia tensor of the third propulsive object used in the physical calculations.

11. The one or more non-transitory computer-readable media according to claim 4, wherein
the game processing further comprises causing a fourth propulsive object among the propulsive objects to generate the propulsive force in an up direction in the virtual space.

12. The one or more non-transitory computer-readable media according to claim 11, wherein
the game processing further comprises controlling the fourth propulsive object so that the greater a predetermined parameter applied based on game processing is, the more increased the propulsive force for the fourth propulsive object and the reference value are.

13. The one or more non-transitory computer-readable media according to claim 11, wherein
the game processing further comprises, while the propulsive force is being generated in the fourth propulsive object, increasing mass and an inertia tensor of the fourth propulsive object used in the physical calculations.

14. An information processing system comprising:
one or more processors that execute game processing comprising:
controlling each of propulsive objects that generates a propulsive force and moves at least based on the propulsive force among dynamic objects which are placed in a virtual space and of which movements are controlled based on physical calculations:
attenuating the propulsive force of the propulsive object in accordance with a moving velocity of the propulsive object; and
when the moving velocity based on physical calculations exceeds a predetermined reference, controlling the propulsive force to be zero.

15. The information processing system according to claim 14, wherein
the game processing further comprises forming an assembly object by linking a plurality of the dynamic objects based on an operation input.

16. The information processing system according to claim 15, wherein
the game processing further comprises:
regarding each of the dynamic objects included in the assembly object, determining a moving velocity based on physical calculations using forces from the dynamic objects to which the dynamic object is linked; and
regarding each of the propulsive objects included in the assembly object, attenuating the propulsive force of the propulsive object in accordance with the moving velocity of the propulsive object.

17. The information processing system according to claim 14, wherein
the game processing further comprises attenuating the propulsive force in accordance with a component of the moving velocity along a direction of the propulsive force, and
the predetermined reference is that the component along the direction of the propulsive force reaches a predetermined reference value.

18. The information processing system according to claim 17, wherein
the game processing further comprises, for a first propulsive object having a first state and a second state among the propulsive objects, continuously generating the propulsive force in a predetermined direction in the first state.

19. The information processing system according to claim 18, wherein
the game processing further comprises, if the first propulsive object is not a part of an assembly object and is in a predetermined orientation, controlling the first propulsive object not to generate the propulsive force in the first state.

20. The information processing system according to claim 18, wherein
the propulsive objects include a second propulsive object, and
the game processing further comprises causing the first propulsive object to generate a contact determination area in the virtual space in addition to the propulsive force, and if the contact determination area comes into contact with the second propulsive object, causing the second propulsive object to generate the propulsive force.

21. The information processing system according to claim 20, wherein
the game processing further comprises, if the contact determination area except for the contact determination area generated by the first propulsive object included in an assembly object including the second propulsive object and the second propulsive object come into contact with each other, causing the second propulsive object to generate the propulsive force.

22. The information processing system according to claim 17, wherein
the game processing further comprises causing a third propulsive object among the propulsive objects to generate the propulsive force for a predetermined period from a timing specified based on an operation input.

23. The information processing system according to claim 22, wherein
the game processing further comprises, while the propulsive force is being generated in the third propulsive object, increasing mass and an inertia tensor of the third propulsive object used in the physical calculations.

24. The information processing system according to claim 17, wherein
the game processing further comprises causing a fourth propulsive object among the propulsive objects to generate the propulsive force in an up direction in the virtual space.

25. The information processing system according to claim 24, wherein
the game processing further comprises controlling the fourth propulsive object so that the greater a predetermined parameter applied based on game processing is, the more increased the propulsive force for the fourth propulsive object and the reference value are.

26. The information processing system according to claim 24, wherein
the game processing further comprises, while the propulsive force is being generated in the fourth propulsive object, increasing mass and an inertia tensor of the fourth propulsive object used in the physical calculations.

27. An information processing apparatus comprising:
one or more processors that execute game processing comprising:
controlling each of propulsive objects that generates a propulsive force and moves at least based on the propulsive force among dynamic objects which are placed in a virtual space and of which movements are controlled based on physical calculations;
attenuating the propulsive force of the propulsive object in accordance with a moving velocity of the propulsive object; and
when the moving velocity based on physical calculations exceeds a predetermined reference, controlling the propulsive force to be zero.

28. The information processing apparatus according to claim 27, wherein
the game processing further comprises forming an assembly object by linking a plurality of the dynamic objects based on an operation input.

29. The information processing apparatus according to claim 28, wherein
the game processing further comprises:
regarding each of the dynamic objects included in the assembly object, determining a moving velocity based on physical calculations using forces from the dynamic objects to which the dynamic object is linked; and
regarding each of the propulsive objects included in the assembly object, attenuating the propulsive force of the propulsive object in accordance with the moving velocity of the propulsive object.

30. The information processing apparatus according to claim 27, wherein
the game processing further comprises attenuating the propulsive force in accordance with a component of the moving velocity along a direction of the propulsive force, and
the predetermined reference is that the component along the direction of the propulsive force reaches a predetermined reference value.

31. An information processing method executed by an information processing system, the information processing method comprising:
controlling each of propulsive objects that generates a propulsive force and moves at least based on the propulsive force among dynamic objects which are placed in a virtual space and of which movements are controlled based on physical calculations;
attenuating the propulsive force of the propulsive object in accordance with a moving velocity of the propulsive object; and
when the moving velocity based on physical calculations exceeds a predetermined reference, controlling the propulsive force to be zero.

32. The information processing method according to claim 31, further comprising forming an assembly object by linking a plurality of the dynamic objects based on an operation input.

33. The information processing method according to claim 32, further comprising:
regarding each of the dynamic objects included in the assembly object, determining a moving velocity based on physical calculations using forces from the dynamic objects to which the dynamic object is linked; and
regarding each of the propulsive objects included in the assembly object, attenuating the propulsive force of the propulsive object in accordance with the moving velocity of the propulsive object.

34. The information processing method according to claim 31, further comprising attenuating the propulsive force in accordance with a component of the moving velocity along a direction of the propulsive force, and
the predetermined reference is that the component along the direction of the propulsive force reaches a predetermined reference value.
